(19) United States
(12) Patent Application Publication
(10) Pub. No.: US 2020/0210401 A1
(43) Pub. Date: Jul. 2, 2020

(54) PROACTIVE AUTOMATED DATA VALIDATION

(71) Applicant: Microsoft Technology Licensing, LLC, Redmond, WA (US)

(72) Inventors: Arun Narasimha Swami, Cupertino, CA (US); Sriram Vasudevan, Sunnyvale, CA (US)

(21) Appl. No.: 16/235,347

(22) Filed: Dec. 28, 2018

(51) Int. Cl. G06F 16/23

(52) U.S. Cl. CPC G06F 16/2365

(57) ABSTRACT

The disclosed embodiments provide a system for processing data. During operation, the system obtains a validation configuration containing declarative specifications of fields in a data set and validation rules to be applied to the data set, wherein the validation rules include a field in the data set, a type of validation to be applied to the field, and a parameter for managing a validation failure during evaluation of the validation rules with the data set. Next, the system automatically applies the validation rules to the data set within a workflow for generating the data set to produce validation results indicating passing or failing of the validation rules by the data set. The system then outputs the validation results for use in managing the data set.

### RELATED APPLICATION

The subject matter of this application is related to the subject matter in a co-pending non-provisional application by the same inventors as the instant application and filed on the same day as the instant application, entitled “Profile-Driven Data Validation,” having serial number TO BE ASSIGNED, and filing date TO BE ASSIGNED (Attorney Docket No. LI-902437-US-NP).

### BACKGROUND

### Field

The disclosed embodiments relate to data analysis. More specifically, the disclosed embodiments relate to techniques for performing proactive automated data validation.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

On the other hand, significant increases in the size of data sets have resulted in difficulties associated with collecting, storing, managing, monitoring, transferring, sharing, analyzing, and/or visualizing the data in a timely manner. For example, machine learning and/or engineering workflows may be disrupted by changes in data schemas; changes in the distribution of values in a data set; incorrect, null, zero, unexpected, missing, out-of-date, and/or out-of-range values in a column or field; and/or other changes, anomalies, or issues with data. Moreover, data-related issues are commonly managed reactively, after the issues result in bugs, anomalies, failures, and/or disruptions in service.

Consequently, management and use of large data sets may be improved using mechanisms for expediting the detection and management of data quality issues.

### BRIEF DESCRIPTION OF THE FIGURES

FIG. 1 shows a schematic of a system in accordance with the disclosed embodiments.

FIG. 2 shows a system for validating and profiling data in accordance with the disclosed embodiments.

FIG. 3 shows a flowchart illustrating the processing of data in accordance with the disclosed embodiments.

FIG. 4 shows a flowchart illustrating a process of performing profile-driven data validation in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

The disclosed embodiments provide a method, apparatus, and system for performing proactive automated data validation. The data may be stored in and/or obtained from multiple data sources, which can include tables, files, relational databases, graph databases, distributed filesystems, distributed streaming platforms, service endpoints, data warehouses, change data capture (CDC) pipelines, and/or distributed data stores. The data may also, or instead, include derived data that is generated from data that is retrieved from the data sources.

More specifically, the disclosed embodiments use validation configurations to perform validation of data sets from the data sources. Each validation configuration may include a declarative specification of fields in a data set. For example, the validation configuration may specify a path, column name, and/or other location or identifier for each field in the data set. In another example, the validation configuration may identify a user-defined function (UDF), expression, and/or other mechanism for generating fields from other fields and/or data.

Each validation configuration additionally includes a declarative specification of validation rules to be applied to the fields and/or the data set. For example, the validation configuration may identify a validation type for each validation rule, a field to which the validation rule applies, and/or one or more parameters for evaluating the validation rule and/or managing a validation failure during evaluation of the validation rule. In turn, the validation rules may be used to validate field values in the data set and/or compare the data set with another data set.

The validation configuration is further tied to a workflow for generating the data set. For example, the validation configuration may be used to validate the data set during execution of an offline or batch-processing workflow for generating the data set. When validation of the data set is triggered (e.g., at a specified time and/or frequency associated with executing the workflow), values of the fields in the data set are retrieved based on the fields' declarative specifications in the validation configuration, and the fields are evaluated using the corresponding validation rules in the validation configuration.

Validation results indicating passed or failed validation rules are then outputted. For example, the validation results may include the overall number of passed and/or failed validation rules, as well as a validation result for each validation rule.

By performing configuration-based validation of data sets, the disclosed embodiments may allow users to proactively and automatically monitor the data sets for anomalies, changes, missing values, and/or other data quality issues. Moreover, declarative representations of the data sets and validation rules may reduce overhead and/or complexity associated with defining the data sets and validation rules while standardizing the application of the validation rules and generation of validation results across data sets and/or data sources. In contrast, conventional techniques may involve the use of scripts, code, and/or other manual or custom solutions that are reactively implemented after failures, poor performance, and/or other issues are experienced by products, services, and/or workflows. Such solutions may additionally be difficult to reuse across data sets and/or may produce validation results that are hidden and/or hard to interpret. Consequently, the disclosed embodiments may provide technological improvements related to the development and use of computer systems, applications, services, and/or workflows for monitoring and/or validating data.

### Proactive Automated Data Validation

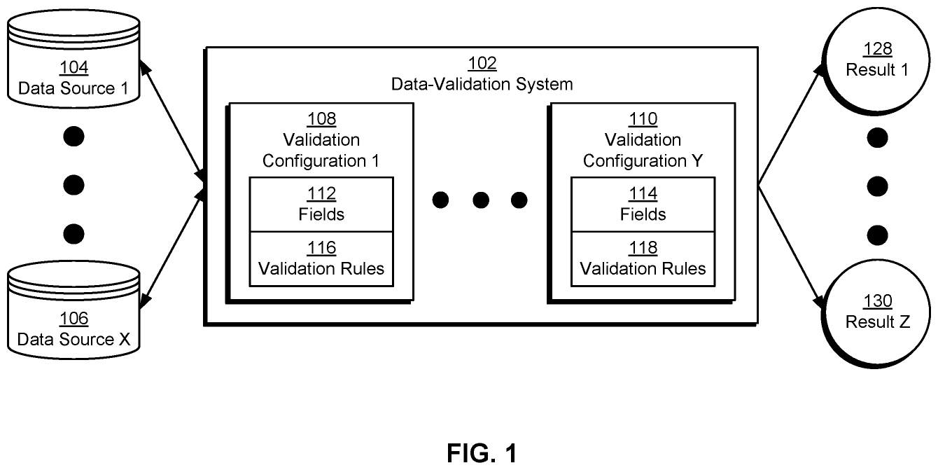

FIG. 1 shows a schematic of a system in accordance with the disclosed embodiments. As shown in FIG. 1, the system includes a data-validation system 102 that monitors and/or analyzes data from a set of data sources (e.g., data source 1 104, data source x 106). For example, data-validation system 102 may process data from tables, files, relational databases, graph databases, distributed filesystems, distributed streaming platforms, service endpoints, data warehouses, change data capture (CDC) pipelines, and/or distributed data stores.

Data-processing system 102 includes functionality to validate the data using a set of validation configurations (e.g., validation configuration 1 108, validation configuration y 110). More specifically, data-validation system 102 identifies a set of fields 112-114 in the validation configurations and retrieves values of fields 112-114 from the corresponding data sources. Data-validation system 102 also obtains validation rules 116-118 from the validation configurations and applies validation rules 116-118 to the corresponding fields 112-114 and/or data sets.

Data-validation system 102 then outputs validation results (e.g., result 1 128, result z 130) produced from the evaluation of validation rules 116-118 with the corresponding fields 112-114. The validation results may indicate passing or failing of each validation rule. As a result, users may view and/or analyze the validation results to monitor the data for anomalies, missing values, changes, schema changes, and/or other data quality issues.

In one or more embodiments, validation configurations include declarative specifications of fields 112-114 and validation rules 116-118. As a result, producers and/or consumers of data sets in the data sources may create the validation configurations and/or use the validation configurations to monitor and/or validate the data sets without implementing functions, methods, and/or operations for retrieving fields 112-114 in the data sets and/or performing validation checks represented by validation rules 116-118. Instead, data-validation system 102 may use the declarative specifications to validate data in a standardized, predictable manner, as described below.

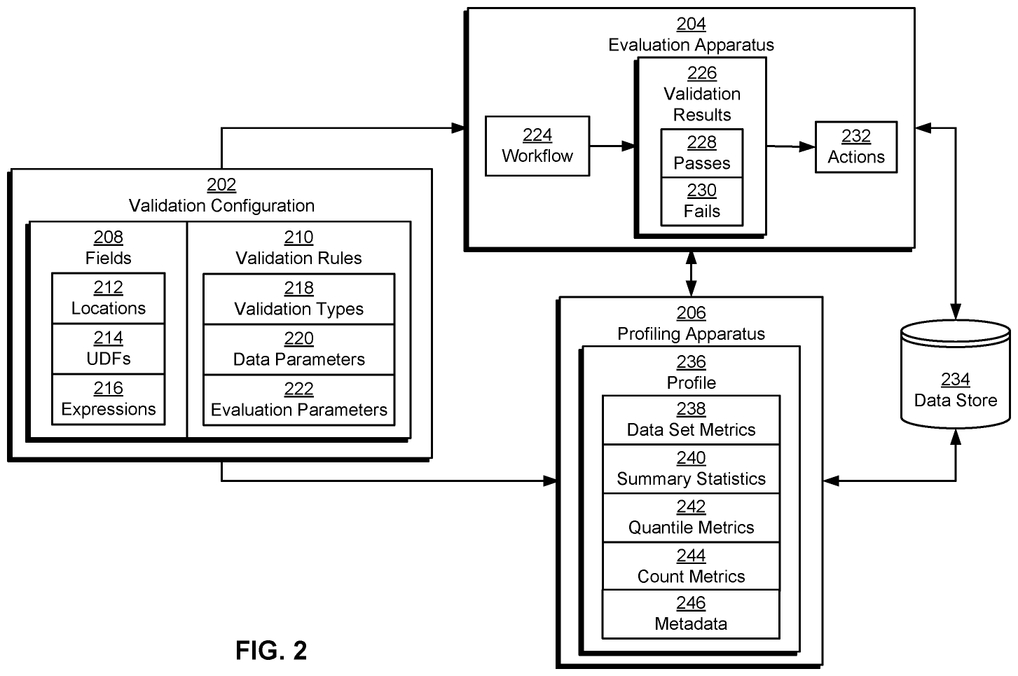

FIG. 2 shows a system for validating and profiling data (e.g., data-validation system 102 of FIG. 1) in accordance with the disclosed embodiments. As shown in FIG. 2, the system includes an evaluation apparatus 204 and a profiling apparatus 206. Each of these components is described in further detail below.

Evaluation apparatus 204 and profiling apparatus 206 use a validation configuration 202 to perform validation and profiling of a data set. Validation configuration 202 may be created by a consumer of the data set, a producer of the data set, and/or another user or entity involved in using and/or monitoring the data set. In particular, evaluation apparatus 204 applies validation rules 210 specified in validation configuration 202 to fields 208 specified in validation configuration 202 to generate validation results 226 related to evaluation of validation rules 210 using values of fields 208. Profiling apparatus 206 generates a profile 236 of the data set from values of fields 208 identified in validation configuration 202.

In one or more embodiments, fields 208 in validation configuration 202 are declaratively specified using locations 212, UDFs 214, and/or expressions 216. Locations 212 may represent paths, Uniform Resource Identifiers (URIs), and/or other attributes that can be used to retrieve fields 208 from a data store 234 and/or another source of data. UDFs 214 may be applied to some fields 208 (e.g., fields from data store 234) to generate derived fields 208 in the data set. Similarly, expressions 216 may include declarative statements (e.g., Structured Query Language (SQL) expression) that are applied to some fields 208 to generate derived fields 208 in the data set.

An example representation of fields 208 in validation configuration 202 includes the following:

configName: ExampleDataValidationConfig
columnDefinitions: [

{

```
  definitionName: b
  columnPath: b
```

}
{

definitionName: sumRowValues
udfPath: com.udf.SumRowValues

}
{

definitionName: UrnShouldStartWithPrefix
columnPath: header
sqlExpr: “““CASE

WHEN pageUrn IS NULL THEN “”
ELSE pageUrn
END”””

udfPath: com.udf.UrnShouldStartWithPrefix

}

]

The representation above includes a configuration name of “ExampleDataValidationConfig,” followed by a “columnDefinitions” portion that specifies fields 208 in a data set. The first field includes a “definitionName” of “b” and a “columnPath” of “b.” As a result, the first field may by identified by the corresponding “definitionName” and retrieved from the corresponding “columnPath.”

The second field under “columnDefinitions” includes a “definitionName” of “sumRowValues” and a “udfPath” of “com.udf.SumRowValues.” Values of the second field may be generated by passing rows of the data set to a UDF that is located at the value assigned to “udfPath.”

The third field under “columnDefinitions” includes a “definitionName” of “UrnShouldStartWithPrefix,” a “columnPath” of “header,” a “sqlExpr” that is assigned to a SQL expression, and a “udfPath” of “com.udf.UrnShouldStartWithPrefix.” Values of the third field may thus be produced by applying the SQL expression to a column located at “header,” and then passing the result of the SQL expression to a UDF that is located at the value assigned to “udfPath.”

In one or more embodiments, validation rules 210 in validation configuration 202 are declaratively specified using validation types 218, data parameters 220, and evaluation parameters 222. In these embodiments, validation types 218 identify different types of validation rules 210 and/or types of validation performed using validation rules 210.

For example, the system of FIG. 2 may support a predefined set of validation rules 210, with each validation rule representing a different type of validation that can be performed on the data set. Some validation types 218 that can be specified in validation configuration 202 may involve the validation of individual fields 208 in the data set. Validation types 218 for validating individual fields 208 may include validations related to null types, such as validating that a field contains all null values, not all null values, and/or no null values. Validation types 218 for validating individual fields 208 may also, or instead, include validations related to Boolean types, such as validating that a field contains all true values, not all true values, all false values, and/or not all false values. Validation types 218 for validating individual fields 208 may also, or instead, include validations related to numeric types, such as validating that a field contains all numeric values, at least one non-zero value, at least one non-positive value, at least one non-negative value, and/or values that fall within a specified range. Validation types 218 for validating individual fields 208 may also, or instead, include validations related to metrics (e.g., summary statistics 240, quantile metrics 242, count metrics 244, etc.) computed from the numeric types, such as verifying that the value of a metric falls within a specified range and/or that a ratio between two metric values falls within a specified range or threshold. Validation types 218 for validating individual fields 208 may also, or instead, include validations related to values of a field, such as validating that the values are distinct, are not identical, match a regular expression, do not match a regular expression, are not empty, contain only a set of specified values, exclude a set of specified values, include one or more values, and/or have timestamp values that are within a certain range of the current time.

Validation types 218 that can be specified in validation configuration 202 may also, or instead, involve the comparison of the data set with another data set. Such comparisons may be applied to schemas, record counts, data volumes, metrics, distribution of values, and/or frequently occurring values in the data set and the other data set. For example, schemas of the data set and an older version of the data set may be compared to verify that the schemas are identical. In another example, record counts, data volumes, and/or metrics related to the data set and older version may be compared to verify that the record counts are within a certain proportion of one another. In a third example, distributions of values in the two data sets may be compared to verify that the distributions do not significantly differ from one another. In a fourth example, a certain number of the most frequently occurring values in the two data sets may be compared for sameness.

Within validation rules 210, data parameters 220 identify fields and/or data sets to which validation rules 210 of certain validation types 218 apply. For example, a data parameter for a validation rule that is applied to a field of a data set may specify the name of the field. In another example, a data parameter for a validation rule that is used to compare two data sets may include names and/or version numbers of the data sets.

In some embodiments, evaluation parameters 222 include parameters with which validation rules 218 are evaluated and/or parameters used to manage validation failures associated with evaluation of validation rules 218. For example, a validation rule that is applied to values of a field may include an evaluation parameter that specifies a threshold, range of values, set of valid values, set of invalid values, regular expression, and/or other value to which the values of the field are compared. In another example, a validation rule may include an evaluation parameter that is used to manage a validation failure associated with the validation rule, such as a parameter that specifies aborting a workflow for generating and/or validating the data set upon detecting the validation failure and/or a parameter for generating an alert of the validation failure. In a third example, the evaluation parameter may specify a threshold for defining the validation failure, such as a maximum number or proportion of records in the data set that can fail evaluation using the validation rule for the data set to pass validation using the validation rule. In a fourth example, the evaluation parameter may specify sampling of records that fail the validation rule, such as the generation of 10 samples of records that fail validation related to null types, Boolean types, numeric types, regular expressions, inclusion or exclusion of specified values, ranges of values, and/or empty values in a field.

An example validation rule in validation configuration 202 includes the following representation:

{

dataAssertionName: i_ExcludeNulls
dataAssertionType: DEFINITION_EXCLUDE_NULLS
dataAssertionDescription: “Exclude nulls from field i”
dataAssertionParameters: {

dataAssertionParameterType: DEFINITION_NAME
dataAssertionParameterValues: i

}

}

The validation rule above includes a name of “i_ExcludeNulls,” a validation type of “DEFINITION_EXCLUDE_NULLS,” a description of “Exclude nulls from field i,” and one parameter that identifies a field named “i.” In turn, the validation rule may verify that values of the field do not contain null values.

Another example validation rule in validation configuration 202 includes the following:

{

dataAssertionName: b_AllFalse
dataAssertionType: DEFINITION_ALL_FALSE
dataAssertionParameters: [

{

dataAssertionParameterType: DEFINITION_NAME
dataAssertionParameterValues: b

}
{

dataAssertionParameterType: SAMPLE_ON_FAILURE
dataAssertionParameterValues: 10

}
{

dataAssertionParameterType: MAX_FAILURE_COUNT
dataAssertionParameterValues: 5

}
{

dataAssertionParameterType: ALERT_ON_FAILURE

}

]

}

The validation rule above includes a name of “b_allFalse,” a validation type of “DEFINITION_ALL_FALSE,” and four parameters. The first parameter identifies a field name “b” to which the validation rule applies, the second parameter specifies a value of “10” for a “SAMPLE_ON_FAILURE” parameter type, the third parameter specifies a value of “5” for a “MAX_FAILURE_COUNT” parameter type, and the fourth parameter specifies an “ALERT_ON_FAILURE” parameter type. As a result, the validation rule may validate that the field named “b” contains all false values, and that validation of the field using the validation rule passes as long as the field contains five or fewer non-false values. If the field fails validation using the validation rule, a sample of 10 records that do not meet the validation rule is generated. An alert of the validation failure is additionally generated before all validation results 226 for validation configuration 202 have been produced.

Another example validation rule in validation configuration 202 includes the following:

{

dataAssertionName: CompareDistributions
dataAssertionType: COMPARE_DISTRIBUTIONS
dataAssertionParameters: [

{

dataAssertionParameterType: DEFINITION_NAME
dataAssertionParameterValues: sumRowValues

}
{

dataAssertionParameterType: SIGNIFICANCE_LEVEL
dataAssertionParameterValues: 0.05

}

]

}

The validation rule above includes a name of “CompareDistributions,” a validation type of “COMPARE_DISTRIBUTIONS,” and two parameters. The first parameter identifies a field name of “sumRowValues” to which the validation rule applies, and the second parameter specifies a value of “0.05” for a “SIGNIFICANCE_LEVEL” parameter type. The second parameter may thus be an evaluation parameter that defines a significance level associated with a comparison of the distribution of values in two data sets (e.g., older and newer versions of the same data set) using the validation rule.

In one or more embodiments, evaluation apparatus 204 produces validation results 226 from validation rules 210 and fields 208 in validation configuration 202 within a workflow 224 for generating the data set. For example, workflow 224 may include a reference to and/or invocation of a validation mechanism that triggers the operation of evaluation apparatus 204 and profiling apparatus 206. As a result, validation of the data set may be automatically performed whenever the data set is generated.

When validation of the data set is triggered (e.g., during execution of workflow 224), evaluation apparatus 204 retrieves values of fields 208 in the data set based on declarative specifications of fields 208 in validation configuration 202. For example, evaluation apparatus 204 may obtain the field values from the corresponding locations 212, by calling the corresponding UDFs 214, and/or by evaluating expressions 216 with data store 234. Next, evaluation apparatus 204 evaluates fields 208 using validation rules 210 in validation configuration 202. For example, evaluation apparatus 204 may perform validations and/or comparisons specified in validation rules 210 according to data parameters 220 that identify fields 208 and/or evaluation parameters 222 for validation rules 210.

Evaluation apparatus 204 then generates validation results 226 indicating passes 228 and/or fails 230 associated with the evaluated validation rules 210. For example, validation results 226 may include the total number of passes 228 and fails 230 associated with evaluation of fields 208 using validation rules 210, as well as an individual validation result of “pass” or “fail” for each validation rule.

Evaluation apparatus 204 optionally performs one or more actions 232 based on validation results 226. For example, evaluation apparatus 204 may generate an alert, notification, and/or other communication of validation results 226 after generation of validation results 226 is complete. Evaluation apparatus 204 may also provide a link to and/or copy of a validation report containing validation results 226 in the communication. In another example, evaluation apparatus 204 may perform one or more actions 232 specified in evaluation parameters 222 for handling validation failures, such as aborting the workflow for generating and/or validating the data set when a certain validation rule fails evaluation and/or generating an alert of the failed validation rule before all validation results 226 have been produced.

Profiling apparatus 206 generates a profile 236 of the data set associated with validation results 226. For example, profiling apparatus 206 may create profile 236 before, during, or after validation of the same data set by evaluation apparatus 204. To create profile 236, profiling apparatus 206 uses information in validation configuration 202 to obtain field values from the corresponding locations 212, by calling the corresponding UDFs 214, and/or by evaluating expressions 216 with data store 234. Profiling apparatus 206 then aggregates the field values into metrics, statistics, and/or metadata 246 related to the corresponding fields and/or the data set.

As shown in FIG. 2, profile 236 includes data set metrics 238, summary statistics 240, quantile metrics 242, count metrics 244, and/or metadata 246. Data set metrics 238 include a record count (i.e., total number of records) for the data set, data volume (i.e., total size of the records) for the data set, and/or other metrics that are representative of the data set. Summary statistics 240 characterize the distributions of values in fields 208 of the data set. For example, summary statistics 240 for fields 208 with numeric values may include a minimum, maximum, mean, standard deviation, skewness, kurtosis, median, and/or median absolute deviation. Quantile metrics 242 include percentiles and/or quantiles associated with values and/or subsets of values in fields 208. Count metrics 244 include counts of different types of values in fields 208, such as counts of the total number of values, distinct values, non-null values, null values, numeric values, zero values, positive values, negative values, false values, true values, and/or frequently occurring values in fields 208.

Metadata 246 includes a last modified time for the data set, the schema for the data set, date ranges for logs related to the data sets, data formats associated with the data set, the version of the data set, a hash or checksum of the data set, and/or other information describing the data set. To produce metadata 246, profiling apparatus 206 may compute some or all portions of metadata 246 using the data set and/or fields 208 in the data set and/or read some or all portions of metadata 246 from other data sources. For example, profiling apparatus 206 may compute a hash from the data set and/or read the schema from the data set, obtain the last modified time of the data set and/or the format of the data set from the filesystem in which the data set is stored, and/or obtain data lineage and/or versioning associated with the data set from a database storing the data set.

After profile 236 is generated, profiling apparatus 206 stores profile 236 in data store 234 and/or another data repository. Profiling apparatus 206 optionally generates an alert, notification, and/or other communication of profile 236.

In one or more embodiments, evaluation apparatus 204 uses data set metrics 238, summary statistics 240, quantile metrics 242, and/or count metrics 244 in profile 236 and/or other profiles produced by profiling apparatus 206 to streamline the evaluation of validation rules 210 for the corresponding data sets. More specifically, evaluation apparatus 204 includes mappings of data set metrics 238, summary statistics 240, quantile metrics 242, and/or count metrics 244 to certain validation types 218 in validation rules 210. When one of the validation types is encountered in a validation rule for a given data set, evaluation apparatus 204 uses one or more corresponding metrics and/or statistics in profile 236 and/or other profiles to evaluate the validation rule instead of analyzing field values in the data set to determine the validation result of the validation rule.

To perform validation of individual fields 208 in the data set, evaluation apparatus 204 matches validation rules 210 associated with the fields to metrics and/or statistics related to the fields in profile 236. Evaluation apparatus 204 then evaluates validation rules 210 using values of the metrics and/or statistics.

As mentioned above, validation rules 210 can be used to validate that a field contains only a subset of values, does not contain only the subset of values, and/or excludes the subset of values. The subset of values may include a null value, a true value, a false value, a numeric value, a positive value, a negative value, a zero value, a range of values, and/or a range of metric values. To perform these types of validations, evaluation apparatus 204 compares the total number of values belonging to that subset in the field with the total number of values in the field. If the values are equal, validation that the field contains only the subset of values passes, while the other two validations fail. If the values are not equal, the validation that the field contains only the subset of values fails, while the validation that the field does not contain only the subset of values passes. If the total number of values belonging to the subset is 0, validation that the field contains only the subset of values fails, while the other two validations pass.

Validation rules 210 can also, or instead, be used to validate that a field contains a range of values and/or that a metric related to the field falls within a range of values. To validate that a field contains a range of values specified in a validation rule, evaluation apparatus 204 may compare the minimum and maximum values for the field from profile 236 to the minimum and maximum values of the range. If the minimum and maximum values from profile 236 fall within the range specified in the validation rule, the validation passes. If the minimum or maximum values fall outside of the range, the validation fails.

To validate that a metric (e.g., minimum, maximum, mean, median, standard deviation, skewness, kurtosis, percentile, etc.) associated with a field falls within a range of values specified in a validation rule, evaluation apparatus 204 may compare the value of the metric in profile 236 to the range. If the value of the metric falls within the range, the validation passes. If the value of the metric falls outside of the range, the validation fails.

Validation rules 210 can also, or instead, specify a maximum number or proportion of records in the data set that can fail evaluation using a given validation rule for the data set as a whole and still pass validation using the validation rule. To evaluate the validation rule, evaluation apparatus 204 may obtain the count of a subset of field values that would fail the validation rule from profile 236 (e.g., a count of false values in a field) and apply a threshold in the validation rule to the count and/or the proportion of the count to the total number of field values. If the count and/or proportion fall below the threshold, the validation passes. If the count and/or proportion exceed the threshold, the validation fails. Consequently, evaluation apparatus 204 includes functionality to perform both “strict” and “soft” validation of the data set using profile 236.

Evaluation apparatus 204 additionally includes functionality to evaluate validation rules 210 involving comparison of the data set with another data set using profiles of the data sets. For example, evaluation apparatus 204 may obtain profiles for a latest version of the data set and an older version of the data set from profiling apparatus 206 and/or data store 234. Evaluation apparatus 204 may then use record counts, data volumes, metrics, distributions of values, and/or frequently occurring values in the profiles of the latest version and older version to evaluate comparison-based validation rules 210 involving the latest version and older version.

By performing configuration-based validation and profiling of data sets, the system of FIG. 2 may allow users to proactively monitor the data sets for anomalies, changes, missing values, and/or other data quality issues while expediting validation of the data sets using metrics in profiles of the data sets. Moreover, declarative representations of the data sets and validation rules may reduce overhead and/or complexity associated with defining the data sets and validation rules while standardizing the execution of the validation rules and generation of validation results across data sets and/or data sources.

In contrast, conventional techniques may involve the use of scripts, code, and/or other manual or custom solutions that are reactively implemented after failures, poor performance, and/or other issues are experienced by products, services, and/or workflows. Such solutions may additionally be difficult to reuse across data sets and/or may produce validation results that are hidden and/or hard to interpret. Conventional techniques may further perform data profiling in isolation from data validation using additional scripts, code, and/or processing, thereby increasing the overhead of implementing and performing both data profiling and data validation. Consequently, the disclosed embodiments may provide technological improvements related to the development and use of computer systems, applications, services, and/or workflows for monitoring, profiling, and/or validating data.

Those skilled in the art will appreciate that the system of FIG. 2 may be implemented in a variety of ways. First, evaluation apparatus 204, profiling apparatus 206, and/or data store 234 may be provided by a single physical machine, multiple computer systems, one or more virtual machines, a grid, one or more databases, one or more filesystems, and/or a cloud computing system. Evaluation apparatus 204 and profiling apparatus 206 may additionally be implemented together and/or separately by one or more hardware and/or software components and/or layers. Moreover, various components of the system may be configured to execute in an offline, online, and/or nearline basis to perform different types of processing related to monitoring and validation of data sets.

Second, validation configuration 202, data sets, validation results 226, profile 236, and/or other data used by the system may be stored, defined, and/or transmitted using a number of techniques. As mentioned above, the system may be configured to retrieve data sets and/or fields 208 from different types of data stores, including relational databases, graph databases, data warehouses, filesystems, streaming platforms, CDC pipelines, and/or flat files. The system may also obtain and/or transmit validation configuration 202, validation results 226, and/or profile 236 in a number of formats, including database records, property lists, Extensible Markup language (XML) documents, JavaScript Object Notation (JSON) objects, and/or other types of structured data.

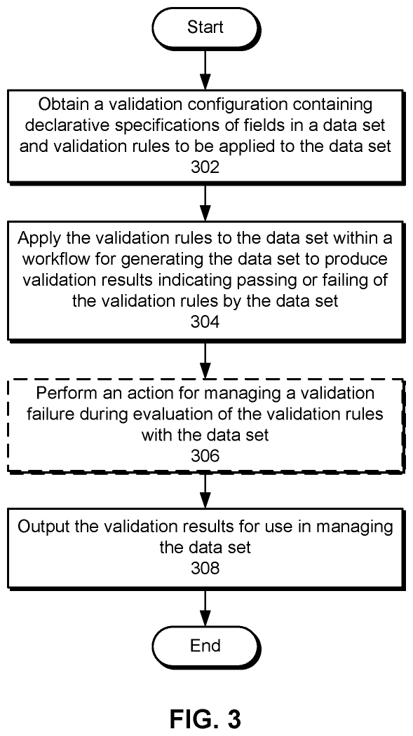

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a validation configuration containing declarative specifications of fields in a data set and validation rules to be applied to the data set is obtained (operation 302). For example, the validation configuration may include a path, column name, and/or other location or identifier for each field in the data set. In another example, the validation configuration may include a user-defined function (UDF), expression, and/or other mechanism for generating fields from other fields. In a third example, the validation configuration may include a validation type for each validation rule, a field to which the validation rule applies, and/or one or more parameters for evaluating the validation rule and/or managing a validation failure resulting from evaluation of the validation rule.

Next, the validation rules are applied to the data set within a workflow for generating the data set to produce validation results indicating passing or failing of the validation rules by the data set (operation 304). For example, the validation rules may be used to perform validations related to null types, Boolean types, numeric types, metrics, and/or field values in the data set. The validation rules may also, or instead, be used to compare schemas, record counts, data volumes, metrics, distributions of values, and/or frequently occurring values between the data set and one or more other data sets.

An action for managing a validation failure during evaluation of the validation rules with the data set is optionally performed (operation 306). For example, the action may be performed according to a corresponding parameter associated with a failed validation rule. The action may include evaluating the validation rule with respect to a threshold for failure specified in the parameter, generating a certain number of samples of failed records specified in the validation rule, aborting a workflow for applying the validation rules to the data set upon detecting the validation failure, and/or generating an alert of the validation failure.

Finally, the validation results are outputted for use in managing the data set (operation 308). For example, one or more alerts, notifications, and/or communications of the validation results may be transmitted to users involved in creating, consuming, and/or monitoring the data set. Links to and/or copies of the validation results may also be provided to the users using the alerts, notifications, and/or communications.

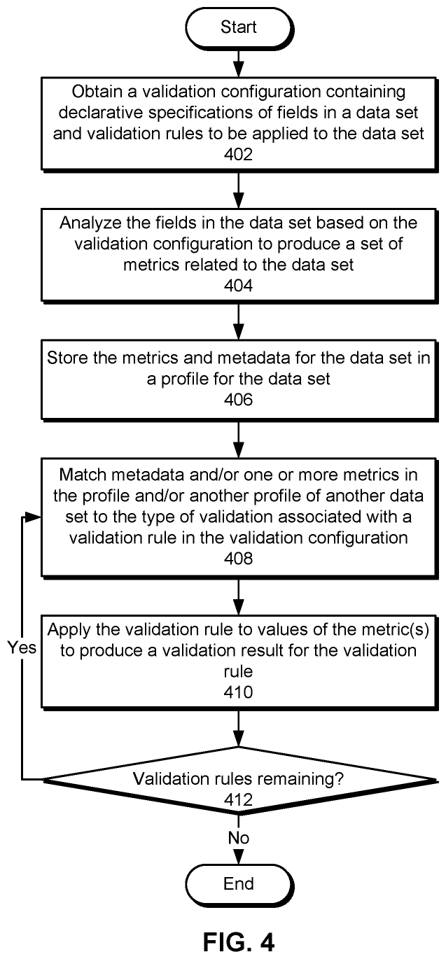

FIG. 4 shows a flowchart illustrating a process of performing profile-driven data validation in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a validation configuration containing declarative specifications of fields in the data set and validation rules to be applied to the data set is obtained (operation 402), as discussed above. Next, the fields in the data set are analyzed based on the validation configuration to produce a set of metrics related to the data set (operation 404), and the metrics and metadata related to the data set are stored in a profile for the data set (operation 406).

For example, fields in the data set may be identified and/or retrieved based on declarations and/or definitions of the fields in the validation configuration. The fields may then be analyzed to compute a count of records in the data set, a data volume of the data set, one or more summary statistics (e.g., minimum, maximum, mean, standard deviation, skewness, kurtosis, median, median absolute deviation, etc.), one or more quantile metrics, and/or one or more count metrics (e.g., counts of total values, distinct values, null values, non-null values, numeric values, zero values, positive values, negative values, false values, true values, etc.). The computed metrics may then be outputted in the profile, which is stored and/or provided for use in monitoring and/or characterizing the data set.

In another example, some metadata related to the data set (e.g., hash, checksum, schema) may be produced and/or obtained from the data set. Conversely, other metadata related to the data set (e.g., last modified time, version, format, etc.) may be obtained from another data source, such as a filesystem and/or repository associated with the data set. The metadata may then be stored with the metrics in the profile of the data set to provide a comprehensive “signature” of the data set.

Some or all validation rules in the validation configuration are then evaluated using the metrics in the profile instead of analyzing field values in the data set. More specifically, metadata and/or one or more metrics in the profile and/or another profile of another data set are matched to a validation rule in the validation configuration (operation 408), and the validation rule is applied to values of the metric(s) to produce a validation result for the validation rule (operation 410).

For example, the validation rule may be used to validate that a field contains only a subset of values (e.g., null values, true values, false values, numeric values, positive values, negative values, zero values, a range of values, a range of metric values, etc.), does not contain only the subset of values, and/or excludes the subset of values. The validation rule may be evaluated by comparing a count of total values in the field with the count of the subset of values in the field. The validation rule may additionally be evaluated based on a threshold for defining a validation failure associated with the validation rule, such as maximum number or proportion of records in the data set that can fail evaluation using the validation rule for the data set to pass validation using the validation rule.

In another example, the validation rule may be used to compare the data set with another data set (e.g., older and newer versions of the same data set). As a result, metrics and/or metadata related to the comparison may be obtained from profiles for the two data sets, and the validation rule may be evaluated using the metrics and/or metadata instead of field values in the data sets.

Operations 408-410 may be repeated for remaining validation rules (operation 412) that can be evaluated using data set profiles. For example, metrics and/or metadata in profiles for data sets may be used to compare two or more data sets and/or validate field values in individual data sets. Validation failures associated with the validation rules may additionally be handled by performing actions specified in the validation rules, as discussed above.

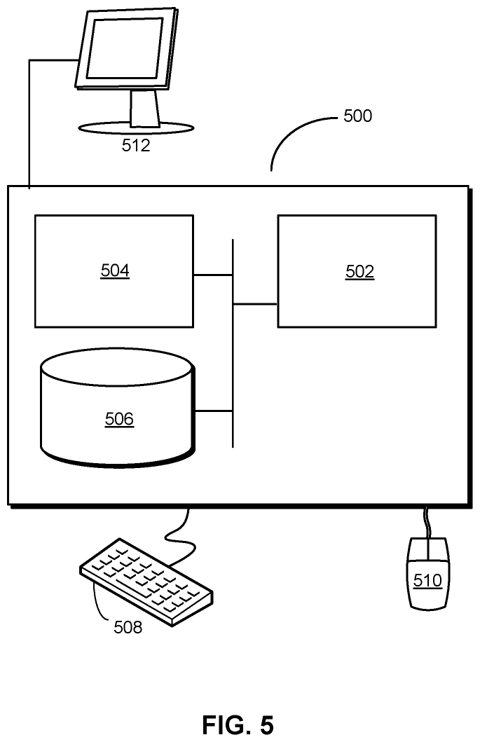

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an evaluation apparatus and a profiling apparatus, one or more of which may alternatively be termed or implemented as a module, mechanism, or other type of system component. The evaluation apparatus obtains a validation configuration containing declarative specifications of fields in a data set and validation rules to be applied to the data set. Next, the evaluation apparatus applies the validation rules to the data set within a workflow for generating the data set to produce validation results indicating passing or failing of the validation rules by the data set.

The profiling apparatus uses information in the validation configuration to generate a profile containing metrics and/or metadata related to the data set. The evaluation apparatus matches metrics and/or metadata in the profile to validation rules in the validation configuration. The evaluation apparatus then applies the validation rules to values of the metrics and/or metadata to produce the validation results. Finally, the evaluation apparatus and/or profiling apparatus output the validation results and/or profile for use in managing the data set.

In addition, one or more components of computer system 500 may be remotely located and connected to the other components over a network. Portions of the present embodiments (e.g., evaluation apparatus, profiling apparatus, data store, data-validation system, etc.) may also be located on different nodes of a distributed system that implements the embodiments. For example, the present embodiments may be implemented using a cloud computing system that performs validation and profiling of data sets from a set of remote data sources.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a validation configuration comprising declarative specifications of fields in a data set and validation rules to be applied to the data set, wherein the validation rules comprise a field in the data set, a type of validation to be applied to the field, and a parameter for managing a validation failure during evaluation of the validation rules with the data set;
applying, by one or more computer systems, the validation rules to the data set within a workflow for generating the data set to produce validation results indicating passing or failing of the validation rules by the data set; and
outputting the validation results for use in managing the data set.

2. The method of claim 1, further comprising:
performing an action specified in the parameter for managing the validation failure.

3. The method of claim 2, wherein the action comprises at least one of:
aborting the workflow for generating the data set upon detecting the validation failure; and
generating an alert of the validation failure.

4. The method of claim 1, wherein applying the validation rules to the data set to produce the validation results comprises:
retrieving, based on the declarative specifications of the fields in the data set, values of the field from the data set; and
evaluating the values of the field using a validation rule represented by the type of validation to be applied to the field in the data set.

5. The method of claim 4, wherein retrieving the values of the field from the data set comprises at least one of:
retrieving the values from a column identified in the declarative specifications;
executing a user-defined function (UDF) identified in the declarative specifications to generate the values of the field; and
executing an expression for generating the values of the field from another field.

6. The method of claim 1, wherein the type of validation comprises at least one of:
a first validation related to a null type;
a second validation related to a Boolean type; and
a third validation related to a numeric type.

7. The method of claim 1, wherein the type of validation comprises at least one of:
a first validation related to a metric; and
a second validation related to values of a field in the data set.

8. The method of claim 1, wherein the type of validation comprises:
a comparison of the data set and another data set.

9. The method of claim 8, wherein the comparison is applied to at least one of:
schemas of the data set and the other data set;
record counts of the data set and the other data set;
data volumes of the data set and the other data set;
metrics associated with the data set and the other data set;
distributions of values in the data set and the other data set; and
frequently occurring values in the data set and the other data set.

10. The method of claim 8, wherein the other data set comprises an older version of the data set.

11. The method of claim 1, wherein the parameter for managing the validation failure comprises at least one of:
a threshold for defining the validation failure with respect to a validation rule; and
a number of samples that fail the validation rule.

12. The method of claim 1, wherein the validation results comprise at least one of:
a number of passed validation rules;
a number of failed validation rules; and
a validation result for each of the validation rules.

13. A system, comprising:
one or more processors; and
memory storing instructions that, when executed by the one or more processors, cause the system to:
obtain a validation configuration comprising declarative specifications of fields in a data set and validation rules to be applied to the data set, wherein the validation rules comprise a field in the data set, a type of validation to be applied to the field, and a parameter for managing a validation failure during evaluation of the validation rules with the data set;
apply the validation rules to the data set within a workflow for generating the data set to produce validation results indicating passing or failing of the validation rules by the data set; and
output the validation results for use in managing the data set.

14. The system of claim 13, wherein applying the validation rules to the data set to produce the validation results comprises:
retrieving, based on the declarative specifications of the fields in the data set, values of the field from the data set; and
evaluating the values of the field using a validation rule represented by the type of validation to be applied to the field in the data set.

15. The system of claim 14, wherein retrieving the values of the field from the data set comprises at least one of:
retrieving the values from a column identified in the declarative specifications;
executing a user-defined function (UDF) identified in the declarative specifications to generate the values of the field; and
executing an expression for generating the values of the field from another field.

16. The system of claim 13, wherein the type of validation comprises at least one of:
a first validation related to a null type;
a second validation related to a Boolean type;
a third validation related to a numeric type;
a fourth validation related to a metric; and
a fifth validation related to values of a field in the data set.

17. The system of claim 13, wherein the type of validation comprises a comparison of at least one of:
schemas of the data set and another data set;
record counts of the data set and the other data set;
data volumes of the data set and the other data set;
metrics associated with the data set and the other data set;
distributions of values in the data set and the other data set; and
frequently occurring values in the data set and the other data set.

18. The system of claim 13, wherein the parameter for managing the validation failure comprises at least one of:
a threshold for defining the validation failure with respect to a validation rule;
a number of samples that fail the validation rule;
aborting a workflow for applying the validation rules to the data set upon detecting the validation failure; and
generating an alert of the validation failure.

19. The system of claim 13, wherein the memory further stores instructions that, when executed by the one or more processors, cause the system to:
perform an action specified in the parameter for managing the validation failure.

20. A non-transitory computer-readable storage medium storing instructions that when executed by a computer cause the computer to perform a method, the method comprising:
obtaining a validation configuration comprising declarative specifications of fields in a data set and validation rules to be applied to the data set, wherein the validation rules comprise a field in the data set, a type of validation to be applied to the field, and a parameter for managing a validation failure during evaluation of the validation rules with the data set;
applying the validation rules to the data set within a workflow for generating the data set to produce validation results indicating passing or failing of the validation rules by the data set;
performing an action specified in the parameter for managing the validation failure; and
outputting the validation results for use in managing the data set.
